(19) United States
(12) Patent Application Publication
(10) Pub. No.: US 2008/0049242 A1
(43) Pub. Date: Feb. 28, 2008

(54) Printing management device, printing management method, and computer readable recording medium storing printing management program

(75) Inventor: Nobuyuki Kimura, Chofu-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 11/699,478

(22) Filed: Jan. 30, 2007

(30) Foreign Application Priority Data
Aug. 23, 2006 (JP) 2006-226529

(51) Int. Cl. G06K 15/00; G06F 15/00

(52) U.S. Cl. 358/1.12

(57) ABSTRACT

Pages are identified as partitioning positions that correspond to partitions of a document. At least one of the identified partitioning positions is, set up as a breakup position for post-processing when post-processing is implemented by breaking it up into sections on printed media.

### CROSS-REFERENCE TO RELATED APPLICATION

This application is based on Japanese Patent Application No. 2006-226529 filed on Aug. 23, 2006, the contents of which are incorporated herein by reference.

### BACKGROUND

1. Technical Field

The present invention relates to a printing management device, a printing management method, and a computer readable medium storing a printing management program, in particular, a printing management device, a printing management method, and a computer readable medium storing a printing management program equipped with functions for post-processing to be applied to printing media after being printed.

2. Description of Related Art

Printing devices such as copying machines, printers and MFPs (Multi-Function Peripherals) equipped with post-processing devices for post-processing printed paper such as stapling have been known.

Up until now, users have been able to designate only whether post-processes such as stapling should be applied to printed paper or not.

However, there is a limit for the maximum number of sheets (upper limit) that can be stapled in one shot in case of stapling multiple sheets of paper due to the limitation of the mechanical capability of the stapling device. Therefore, when the number of sheets to be post-processed exceeds the specified upper limit, stapling them would not only result in poor stapling quality but also might damage the stapling device.

In order to solve this problem, a method has been proposed to cancel stapling when the number of sheets of paper to be stabled exceeds the specified upper limit. See Japanese Unexamined Publication No. 11-291583.

However, the system described in the above mentioned patent document results in completely disregarding the user's wish to execute a stapling process to the paper after printing.

Furthermore, a method has been proposed to execute a stapling process by breaking it into multiple batches when the number of sheets of paper to be stapled exceeds a specified upper limit. See Unexamined Publication No. 2001-63912. In this case, the printing paper to be post-processed is broken into several batches in a balanced way so that no batch becomes too small.

However, the invention described in the patent document breaks up the printing paper to be post-processed into batches of arbitrary number of sheets so that it ends up stapling a printed product breaking up at completely undesirable pages thus producing a product that the user cannot appreciate.

### OBJECTS AND SUMMARY

It is an object of the present invention to provide a printing management device, a printing management method, and a computer readable medium storing a printing management program, which are improved for solving the abovementioned problems.

To achieve at least one of the abovementioned objects, a printing management device reflecting one aspect of the present invention includes an identification unit and a control unit. The identification unit identifies partitioning positions that correspond to partitions of a document. The control unit specifies at least one of the identified partitioning positions as a breakup position for post-processing when post-processing is implemented by breaking it into several sections on the printed media.

In the abovementioned printing management device, said partitioning position should preferably be located on a page where a chapter break of the document occurs.

In the abovementioned printing management device, said partitioning position should preferably be on a page where an insertion sheet is inserted into the document.

In the abovementioned printing management device, said partitioning position should preferably be on a page where a printing setup condition of the document changes.

It is preferable that the abovementioned printing management device further includes an execution approval/rejection receiving unit for receiving the user's instruction on whether to approve or reject the execution of said post-processing by breaking it into several sections.

In the abovementioned printing control unit, said execution approval/rejection receiving unit should preferably receive the user's instruction on whether to approve or reject the execution of said post-processing by breaking it into several sections individually for each one of a plurality of types of said partitioning positions.

It is preferable that said printing management device further includes a priority instruction receiving unit for receiving the user's instruction as to the priority to be used in setting up a particular breakup position among said plurality of types of partitioning positions.

In the abovementioned printing management device, the breakup of said post-processing should preferably be limited to a case where the number of recording media to be post-processed exceeds a particular upper limit.

Even when said object to be post-processed is divided into multiple sectors in said printing management device, if the number of recording media to be post-processed at least in one sector among the particular multiple sectors broken up as described above exceeds said specified upper limit, said control unit further should be able to set up a different type of partitioning position, which is different from the partitioning position used as said breakup position, as a second breakup position of said object to be post-processed.

If the number of recording media to be post-processed at least in one sector among the particular multiple sectors broken up as described above exceeds said specified upper limit when said object to be post-processed is broken up into multiple sectors in said printing management device, said control unit further should preferably be able to set up a position that breaks up the particular sector evenly so that the number of recording media to be post-processed does not exceed said specified upper limit as a second breakup position of said object to be post-processed.

It is preferable that the abovementioned printing management device further includes a choice receiving unit for receiving the user's choice concerning whether or not to limit the breakup of said post-processing only to a case when the number of recording media to be post-processed exceeds a specified upper limit.

In the abovementioned printing management device, the number of recording media to be post-processed should preferably be calculated in accordance with the printing condition specified by the user's operation.

To achieve at least one of the abovementioned objects, a printing management device reflecting one aspect of the present invention includes a receiving unit and a control unit. The receiving unit receives the setup start request concerning document printing. The control unit is in charge of controlling the display of a setup screen comprising a partitioning position setup section for setting up a partitioning position that corresponds to a partition of a document in accordance with the user's instruction. At least one of the designated partitioning positions is set up here as a breakup position of the object of post-processing when the post-processing is applied to the recording media after printing.

The objects, characteristics and properties of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a printing system according to a first embodiment of the present invention.

FIG. 2 is a block diagram showing the constitution of the PC shown in FIG. 1.

FIG. 3 is a block diagram showing the constitution of the MFP shown in FIG. 1.

FIG. 4 is a substantially front view of the MFP shown in FIG. 1.

FIG. 5 is a flowchart showing the sequence of the transmission process for the print data in the PC.

FIG. 6 shows an example of a printing setup screen.

FIG. 7 shows an example of a printing setup screen containing a chapter break function setup section.

FIG. 8 is a flowchart showing the process sequence in the MFP for receiving print data.

FIG. 9 is a flowchart showing the process of deciding a breakup position.

FIG. 10 shows an example of a per page setting screen.

FIG. 11 is a flowchart showing the process for deciding a breakup position according to a second embodiment of the invention.

FIG. 12 is a flowchart showing the process for transmitting print data on a PC according to a third embodiment of the invention.

FIG. 13 is a flowchart showing the process for receiving print data on a MFP according to the third embodiment of the invention.

### DETAILED DESCRIPTION OF THE PREFERRED EMBODIMENT

The embodiments of this invention will be described below with reference to the accompanying drawings.

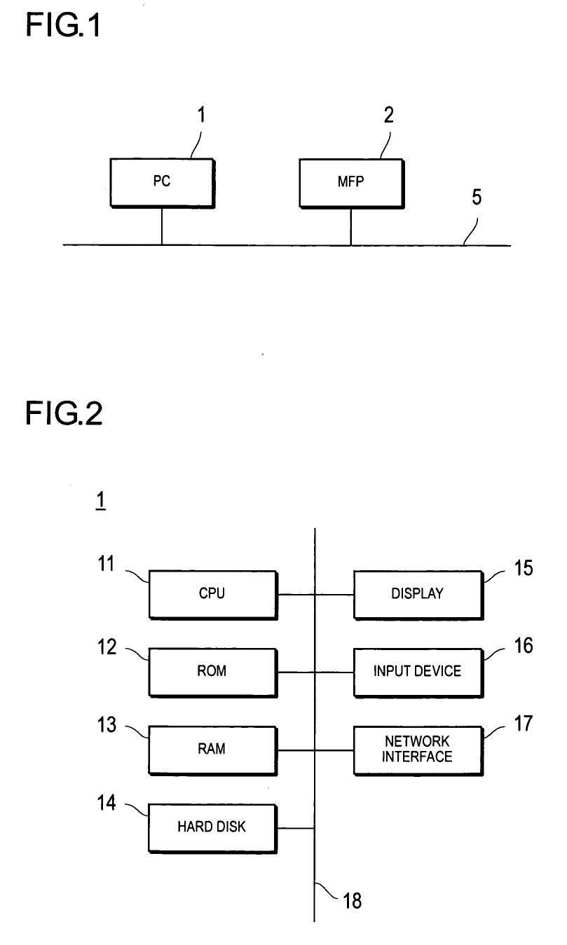

FIG. 1 is a block diagram showing the overall constitution of a printing system according to a first embodiment of the present invention.

The printing system according to this embodiment is equipped with a PC (personal computer) 1 as a printing instruction device and a MFP 2 as a printing device, which are connected via a network 5 to communicate with each other. The types and the number of equipment to be connected to the network 5 are not limited to those shown in FIG. 1. Also, the PC 1 and the MFP 2 can be connected directly (local connection) without recourse to network 5.

FIG. 2 is a block diagram showing the constitution of the PC shown in FIG. 1.

The PC 1 contains a CPU 11, a ROM 12, a RAM 13, a hard disk 14, a display 15, an input device 16 and a network interface 17, all of which are interconnected by a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system and data.

The hard disk 14 stores an application program for generating document files and a printer driver for converting the document files into print data described in a language understood by the MFP 2 installed. The printer driver is capable of instructing printing of the document files generated by the application program and designating the printing conditions of the document files to be printed.

The display 15 displays various kinds of information. The input device 16 includes a pointing device such as a mouse, a keyboard, and others, and is used for executing various kinds of inputs. The network interface 17 is an interface for communicating with other devices via the network 5 using standards such as Ethernet®, Token Ring, FDDI, etc.

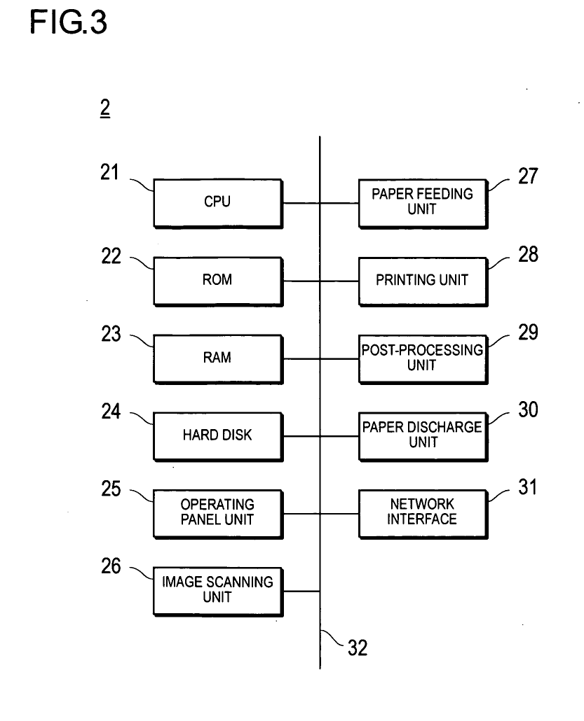

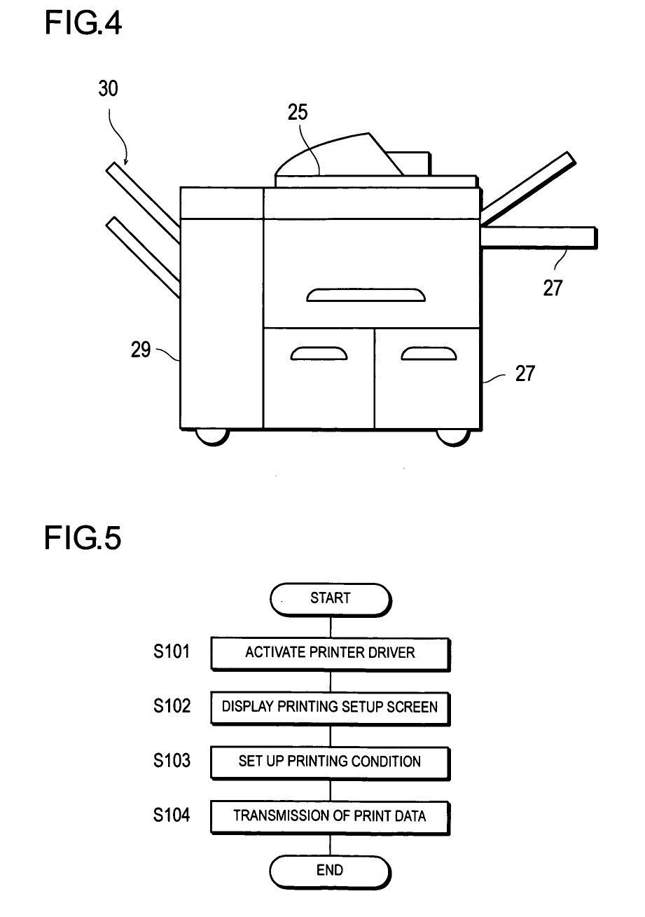

FIG. 3 is a block diagram showing the constitution of the MFP 2 shown in FIG. 1, and FIG. 4 is a substantially front view of the MFP 2 shown in FIG. 1

The MFP 2 has a CPU 21, a ROM 22, a RAM 23, a hard disk 24, an operating panel 25, a document scanning unit 26, a paper feeding unit 27, a printing unit 28, a post-processing unit 29, a paper discharge unit 30, and a network interface 31, all of which are interconnected with each other via a bus 32 for exchanging signals. The descriptions of those parts of the MFP 2 that have the same functions as those of the corresponding parts of the PC 1 will be omitted here to avoid being duplicative.

The operating panel unit 25 is equipped with a touch panel, a ten-key pad, a start button, a stop button and others to be used for displaying various data and entering various instructions.

The document scanning unit 26 illuminates the document with fluorescent lamp or others, converts reflecting light to electrical signals by means of light receiving devices such as CCD, and generates image data from the electrical signals.

The paper feeding unit 27 stores paper used as a recording medium in printing. The paper feeding unit 27 feeds the stored paper one sheet at a time to the printing unit 28.

The printing unit 28 prints images indicated by image data on paper using a known imaging process such as the electronic photographing process including such processes as electrical charging, exposure, developing, transferring and fixing.

The post-processing unit 29 applies post-processes on the recording media after printing. The post-processes include stapling process for stapling bundles of paper, folding process for folding paper, and punching process for punching holes on the edge of paper for filing.

The paper discharge unit 30 is equipped with a paper tray or preferably paper trays for printed and post-processed paper to be discharged to as needed.

The PC 1 and the MFP 2 can each contain constitutional elements other than those described above, or may lack a portion of the abovementioned elements.

The network 5 can be a LAN connecting computers and network equipment according to standards such as Ethernet®, Token Ring, and FDDI, or a WAN that consists of several LANs connected by a dedicated line.

The operation of the printing system in this embodiment will be described in the following.

FIG. 5 is a flowchart showing the sequence of the transmission process for the print data in the PC 1. The algorithm shown in the flowchart of FIG. 5 is stored as a program in a memory unit such as a hard disk 14 of PC 1 and executed by CPU 11.

As a preamble, a document file to be printed is prepared by the PC 1. The document file is prepared by an application installed on the PC 1.

When executing the document file printing process, the request for the start of setup for document printing is received based on the user's operation (S101). In other words, the printer driver is activated via the printing setup dialog of the application program.

Next, the printing setup screen is displayed on the display 15 by the printer driver (S102).

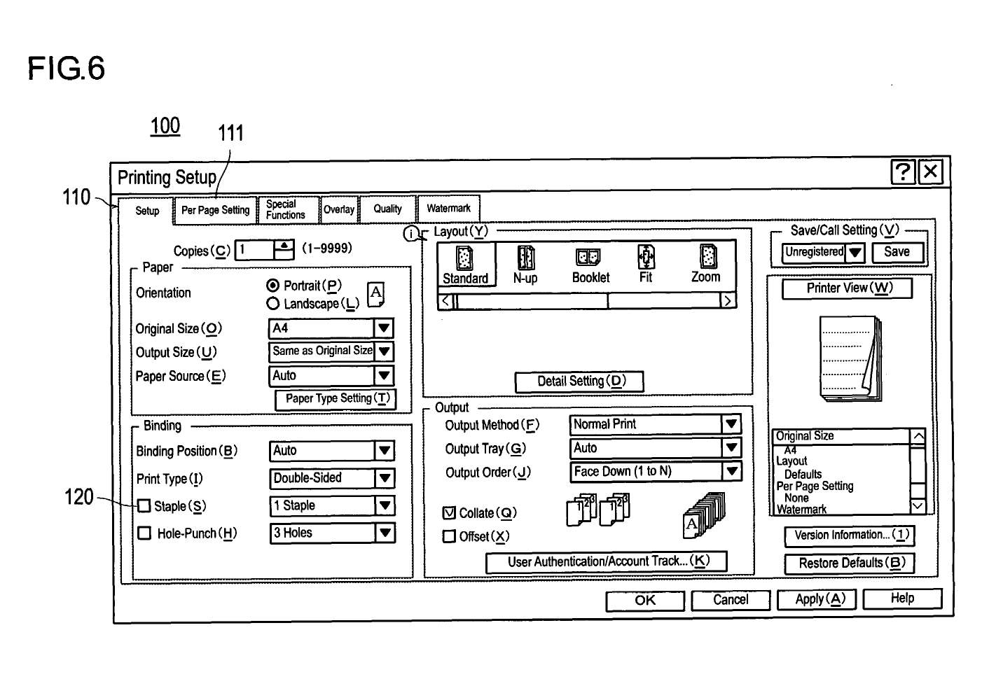

FIG. 6 shows an example of a printing setup screen 100.

The printing setup screen 100 contains multiple printing function setup tabs 110 with multiple function items. The user can choose a desired function item from the printing function setup tabs 110 and designate details concerning the particular function item. The printing setup screen 100 also has checkboxes 120 for designating post-processing such as stapling. The printing setup screen 100 preferably has an execution approval/rejection instruction receiving section (unit) for receiving the user's instruction on whether to approve or reject the implementation of said post-processing by breaking it up. Thus, it can properly accommodate a user who doesn't want to have the post-processing to be automatically broken up.

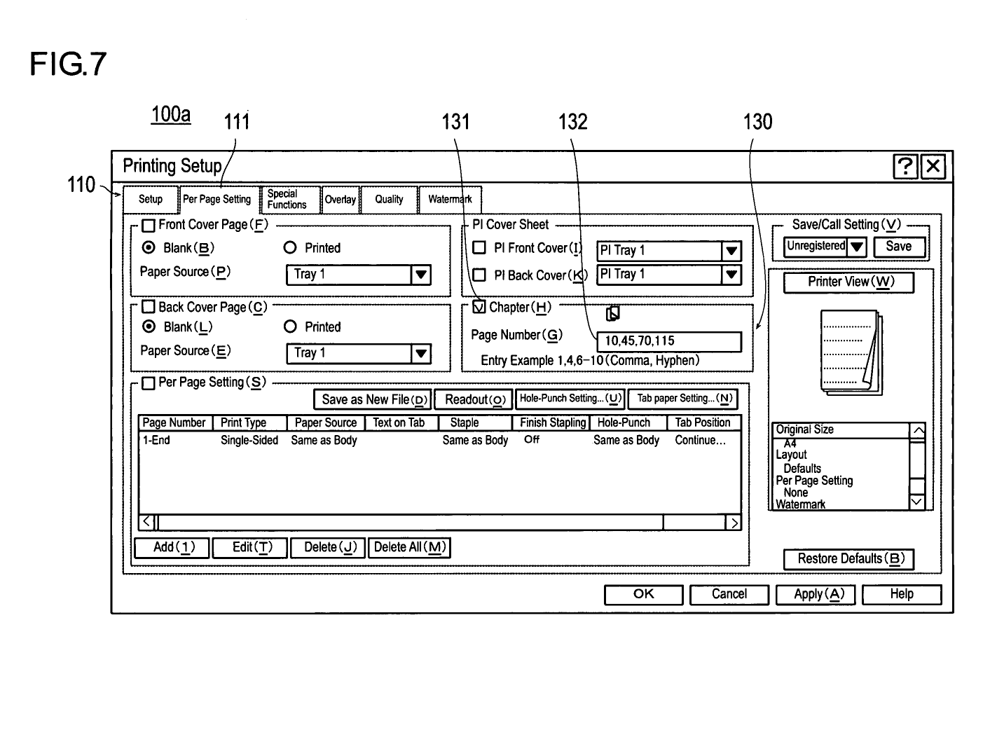

FIG. 7 shows an example of a printing setup screen 100a containing a chapter break function setup section 130.

The printing setup screen 100a is a screen which is displayed when a per page setting tab 111 among various printing function setup tabs 110 on the printing setup screen 100 shown in FIG. 6 is clicked by the user. A chapter break function setup section 130 of the printing setup screen 100a includes a check box 131 for setting up the chapter break function and an input box 132 for designating a page at the end of a chapter. The chapter break function here means a function of automatically arranging the page specified by the user on the surface in case of double-sided printing. In example of FIG. 7, pages 10, 45, 70 and 115 are specified as the pages where chapter breaks occur. These pages indicate various partitions of the document for the user. In other words, there are various partitions within the document intended by the user.

Getting back to the flowchart shown in FIG. 5, various printing conditions are set up in step S103 based on the user's operations on the printing setup screen (S103). At this time, the printing conditions including the presence or lack of designation of the staple process and the presence or lack of designation of the chapter break function can be designated.

Next, the printer driver prepares print data by converting the document file and transmits the prepared print data to the MFP 2 as a printing job (S104). The print data is prepared using a page description language (PDL). The print data includes the printing condition setup.

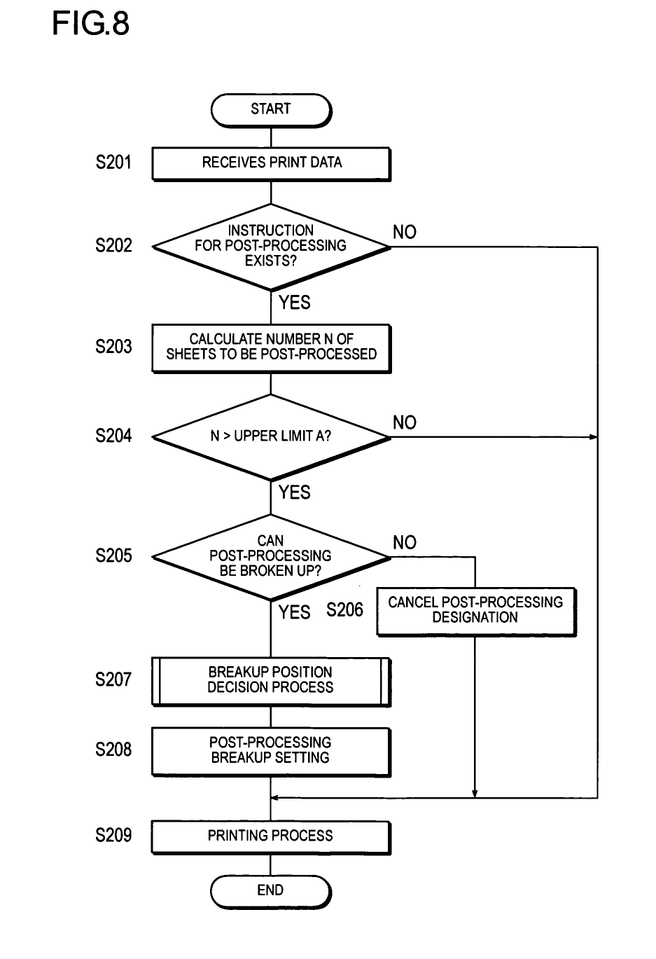

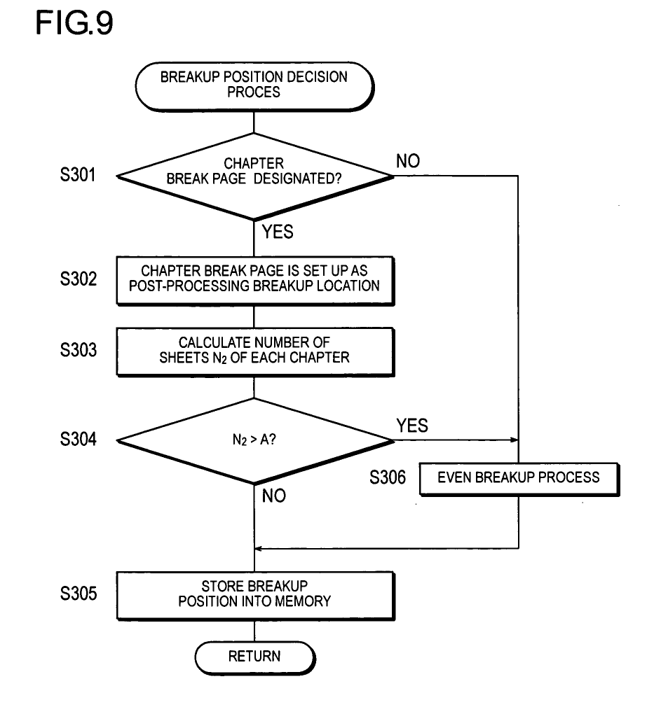

FIG. 8 and FIG. 9 are flowcharts showing the process sequence in the MFP 2 for receiving print data. The algorithm shown in the flowchart of FIG. 8 and FIG. 9 is stored as a program in a memory unit such as the hard disk 24 of the MFP 2 and executed by the CPU 21.

First, the MFP 2 receives print data from the PC 1 as the printing job (S201).

Next, a judgment is made as to whether any post-processing is designated for the received print data (S202). More specifically, a judgment is made as to whether or not any stapling process is designated in case of the present embodiment. However, it can be so constituted as to make a judgment on whether there is any post-processing, such as a folding process is designated or not. If it is judged that no post-processing is designated (S202: No), the program advances to step S209.

If it is judged that post-processing has been designated (S202: Yes), the number of sheets N to be post-processed will be calculated (S203). The number of sheets N to be post-processed will be calculated from the number of pages of the document and the printing conditions that affect the number of sheets to be post-processed. The printing conditions that affect the number of sheets to be post-processed after printing include, for example, the designation of both or single side printing, the designation of insertion of insertion sheets such as tab sheets, the designation of N-in-1 printing (function of printing the contents of a plurality of pages in one page), and the designation of booklet printing.

A judgment is made in step S204 as to whether or not the number of sheets N to be post-processed is larger than a specified upper limit A.

The specified upper limit A is a value to be determined from the limit of the mechanical capability of the post-processing unit. For example, in case of a stapling process such as in the present embodiment, it may be set up as A=50 (sheets) based on the mechanical capacity limit such as the length of the needle to be used in the-post processing. At this point, the mechanical capability limit of the post-processing unit stored in advance in the memory unit of the MFP 2 can be obtained as the specified upper limit A.

However, if it is a case of simultaneously folding multiple sheets of paper, the specified upper limit A may be designated as A=15 (sheets) based on the mechanical capacity limit of the folding unit. Typical simultaneously folding processes for multiple sheets of document include two-fold, which is to fold a sheet in the middle, and three-fold, which is to fold a sheet at a point either ⅓ and ⅔ of the total width from an edge of the sheet and is used often for inserting a sheet into an envelope.

If it is judged that N≦A in step S204 (S204: No), the program advances to step S209. In other words, the post-processing can be easily implemented without being broken up if it is within the mechanical capacity of the post-processing unit. However, it is also possible to adopt a constitution for breaking up the post-processing even if it happens within the mechanical capacity of the post-processing unit. The printing setup screen 100 preferably has a choice receiving section (unit) for receiving the user's choice concerning whether or not to limit the breakup of said post-processing only to a case when the number of sheets to be post-processed exceeds a specified upper limit A. Such a constitution enables the user to break up the post-processing objects at various partitioning positions that correspond to partitions of a document as the user wishes.

On the other hand, if it is judged as N>A in step S204 (S204: Yes), it is judged whether it is possible to break up the post-processing or not (S205). This judgment is made by checking whether a printing system allows breaking up the post-processing. In case of a printing system allows designating the post-processing only per printing job not per page, the user cannot instruct to break up the post-processing within a single printing job. In other words, the post-processing can be broken up if the post-processing designation per page is possible. However, even if the post-processing cannot be designated directly per page, it can be judged that breakup of the post-processing is indirectly possible if a plurality of discharge destinations exists for printed materials, if the post-processing can be implemented for each discharge destination, and if the discharge destinations can be changed per page.

If it is judged that it is impossible to break up the post-processing in step S205 (S205: No), the designation of the post-processing will be cancelled (S206). In this case, it is possible to constitute the system in such a way as to halt the printing job temporarily, and accept the user's choice as to continue the execution of the printing job, or to delete the printing job. A section for allowing the user to designate continuing the execution of the printing job or deleting the printing job is preferably shown on the screen.

If it is judged that it is possible to divide the post-processing in step S205 (S205: Yes), the process of deciding breakup positions will be implemented (S207). The details of the process of deciding breakup positions will be described later.

Next, the post-processing breakup is set up based on the breakup position decided in step S207 (S208). More specifically, the designation for the post-processing breakup position is generated. If in case the post-processing breakup positions cannot be designated within one printing job, if there are several discharge destinations for printed materials and if post-processing can be executed in correspondence with each discharge destination, the designation for a change of the discharge destinations is generated. It is also possible to break up a printing job into several subdivisions to create a printing job consisting of several sub-jobs.

In step S209, the printing process is performed. In other words, images represented by print data are printed on paper and the post-processing is applied to the printed paper based on the designated breakup positions.

Next, the decision process for the breakup positions with reference to FIG. 9 is described.

First, a judgment is made on whether or not there is any chapter break function designated for the print data, or more specifically, a judgment is made on whether or not there is any page designated for chapter breaks (S301). At this point, the pages denoting chapter breaks are identified as partitioning positions that correspond to partitions of a document (S301: Yes). If no page exists to denote a chapter break (S301: No), the program advances to step S306.

If a page denoting a chapter break exists (S301: Yes), the page that denotes the chapter break is set up as the breakup position of the post-processing object (S302). However, there is no need for the post-processing to be broken up at all the pages that denote chapter breaks. In other words, at least one of the pages that denote chapter breaks can be set up as the breakup position of the post-processing object so long as the number of sheets to be post-processed simultaneously does not exceed the specified upper limit A.

Next, the number of sheets that constitute each chapter N₂ is calculated when the post-processing object is broken up at pages that denote chapter breaks (S303).

Next, a judgment is made as to whether the number of sheets of each chapter N₂ is larger than the specified upper limit A (S304).

If it is judged that N₂>A (S304: Yes), the program advances to the step S306.

In the step S306, the even breakup process is performed. In other words, the position that evenly breaks up the post-processing object so that the number of sheets to be post-processed simultaneously does not exceed the specified upper limit A is set up as the breakup position of the post-processing object. Such a constitution makes it sure to avoid a situation where the post-processing cannot be executed.

If it is judged that N₂≦A in step S304 (S304: No), the program advances to step S305.

The breakup positions set up for the post-processing object are stored into the RAM 23 in step S305. Thus, the breakup positions are decided.

In the present embodiment, as can be seen from the above, the pages that denote the chapter breaks within a document are identified, and the pages that denote the chapter breaks are set up as the breakup locations for the post-processing in case the post-processing is to be executed on the printed sheets by breaking it up into several sections.

Thus, the printing paper to be the post-processing object shall be broken up at the pages that denote the chapter breaks specified by the user. In other words, it becomes possible to implement the breakups of the post-processing as the user desired.

Next, the second embodiment of the invention will be described below. The following description will concentrate mainly on those points that are different from the first embodiment.

Although the pages that denote the chapter breaks are used as the partitioning positions that correspond to partitions of a document in the first embodiment, the pages where tab sheets are inserted are used as the partitioning positions in the second embodiment.

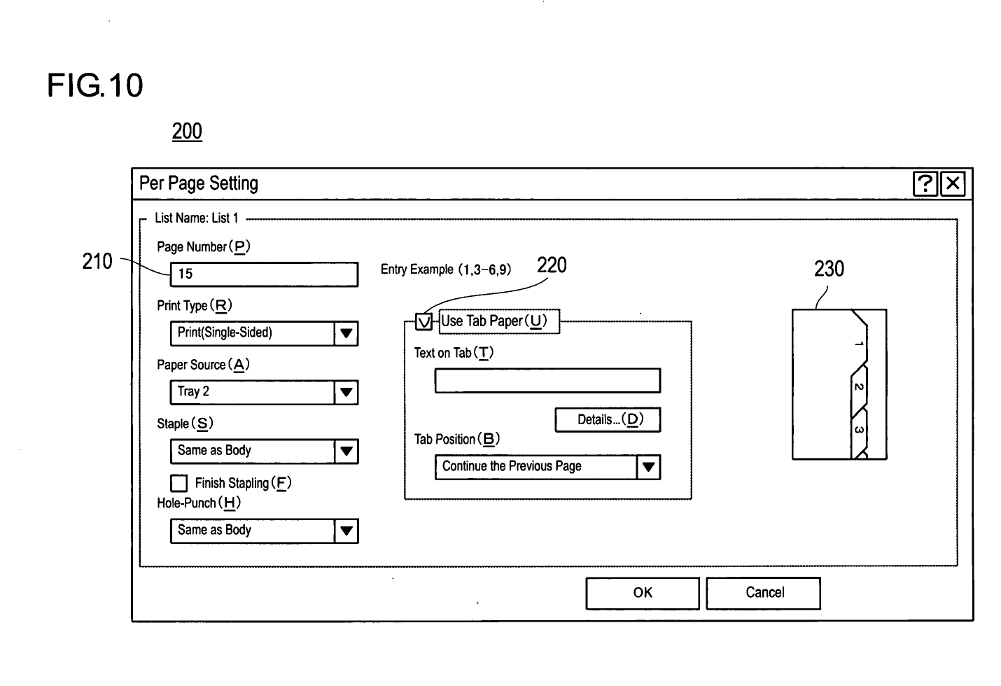

FIG. 10 shows an example of a per page setting screen 200.

The setup screen 200 is one of the printing setup screens to be display on the display 15 of the PC 1 by the printer driver.

The setup screen 200 includes a page position setup section 210 for the user to specify the page number to be set up, and a checkbox 220 for specifying whether or not to insert a tab paper at the page specified in the page position setup section 210. The tab paper is also called the index paper having a rectangular main body and a protruding tab provided at a specific position of one side of said main body (see the preview image 230 of FIG. 10).

In the second embodiment, various printing conditions such as whether stapling is designated or not and whether tab sheets are inserted or not are set up in step S103 of FIG. 5.

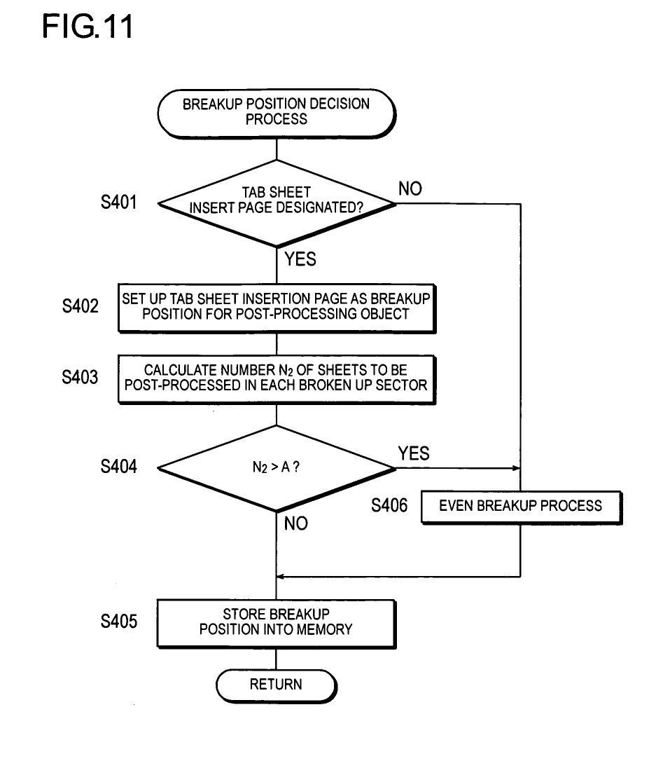

FIG. 11 is a flowchart showing the process for deciding a dividing position according to the second embodiment. The algorithm shown in the flowchart of FIG. 11 is stored as a program in a memory unit such as a hard disk 24 of MFP 2 and executed by a CPU 21.

First, a judgment is made as to whether or not tab sheet insertion is designated in the print data, more specifically, whether or not a page is designated for tab sheet insertion in the document (S401). If a page for tab sheet insertion is not designated (S401: No), the program advances to step S406.

If a page is designated for tab sheet insertion (S401: Yes), the page for tab sheet insertion is setup as the breakup position of the post-processing object (S402). However, there is no need to break up the post-processing at every tab sheet insertion position, and it is possible to set up only one of the tab sheet insertion pages as the post-processing breakup position.

Next, the number N₂ of sheets that are post-processed in each sector is calculated when the post-processing object is broken up into multiple sectors at tab sheet insertion pages (S403).

Next, a judgment is made as to whether the number N₂ of sheets post-processed in each broken up sector is larger than the specified upper limit A (S404).

If it is judged that N₂>A (S404: Yes), the program advances to the step S406.

An even breakup process similar to that of step S306 shown in FIG. 9 is performed in step S406.

If it is judged that N₂≦A in step S404 (S404: No), the program advances to step S405.

The breakup positions setup for the post-processing object are stored into the RAM 23 in step S405. Thus, the breakup positions are decided.

In this embodiment, as shown above, the page where a tab sheet is inserted is identified in the document and the identified page where the tab sheet is to be inserted is set up as the post-processing object breakup position when the post-processing to be applied to the printed paper is executed by breaking it up into multiple sectors.

Therefore, the paper which is to become the post-processing object is broken up by the tab sheet inserting pages specified by the user. In other words, the post-processing breakup can be implemented based on the user's wish in the second embodiment as well as in the first embodiment.

It is also possible to use the pages where other types of insertion paper such as white paper are inserted in a document as the partitioning positions that correspond to partitions of the document. Moreover, the pages where the printing condition changes can also be used as the partitioning positions that correspond to partitions of the document. The changes of the printing condition include a change between single and double sided printing, a change in paper supply tray, a change in paper discharge tray, a change in paper type (paper color, weight, perforation, paper quality, etc.), a change in paper size, a change in printing direction, and a change between color and monochromatic printing. The changes of the printing condition are made, for example, on a printing setup screen.

A partitioning position of a kind different from that of the partitioning position already used as a breakup position can be set up as a second partitioning position for the post-processing object in step S306 shown in FIG. 9 and step S406 shown in FIG. 11. In other words, a page for inserting a tab sheet in the document can be set up as a breakup position in step S306 shown in FIG. 9. Also, a page designating a chapter break in the document can be set up as a breakup position in step S406 shown in FIG. 11. Also, a page where the printing condition changes in the document can be set up as the breakup position in step S306 shown in FIG. 9 and/or step S406 shown in FIG. 11. Such a constitution makes it possible to avoid a situation where the post-processing cannot be executed while reflecting the user's intention.

It is also possible to constitute the system in such a way as to accept the user's instruction concerning the priority for setting up the breakup positions among the abovementioned plurality of partitioning positions. Such a constitution makes it possible to avoid a situation where the post-processing cannot be executed while further reflecting the user's intention. In that case, the printing setup screen may include a priority instruction receiving section (unit) allowing the user to input the priority as user's discretion.

It is also possible to adopt a constitution for accepting the user's instruction as to whether or not to execute the post-processing by breaking it up at each of the abovementioned plurality of types of partitioning positions. Such a constitution enables the user to select a preferable one from the plurality of partitioning positions as the breakup position of the post-processing object. The printing setup screen may include execution approval/rejection receiving section so that the user can input instruction as to whether or not to execute the post-processing by breaking it up at each of the abovementioned plurality of types of partitioning positions.

Next, the third embodiment of the invention will be described below. The following description will concentrate mainly on those points that are different from the first embodiment.

While the breakup position decision process (S207) is executed by the MFP 2 in the first embodiment, the breakup position decision process in the third embodiment is executed by the printer driver of the PC 1. As can be seen from the above, the printing management device according to the present invention for setting up at least one of the partitioning positions that correspond to identified partitions of a document as the post-processing object breakup position in case when the post-processing is applied to the printed paper by breaking it up can be applied to the PC 1 as a printing instruction device or to the MFP 2 as a printing device.

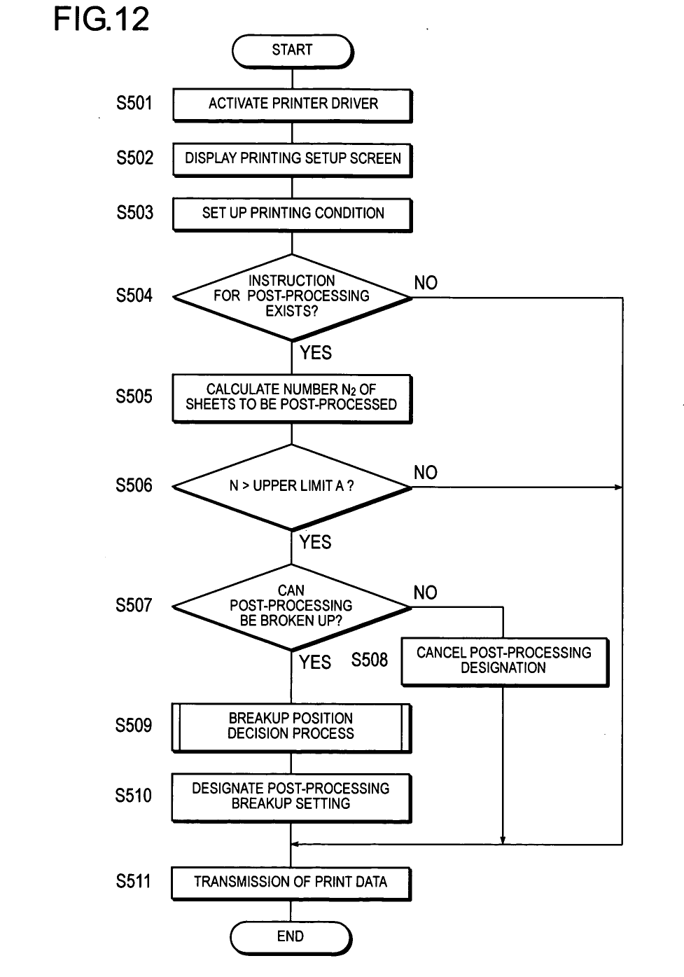

FIG. 12 is a flowchart showing the process for transmitting print data on a PC 1 according to the third embodiment. The algorithm shown in the flowchart of FIG. 12 is stored as a program in a memory unit such as a hard disk 14 of PC 1 and executed by CPU 11.

Since the steps S501 through S503 are identical to the steps S101 through S103, their descriptions are omitted.

Since the steps S504 through S509 are identical to the steps S202 through S207, their descriptions are omitted. In step S506, however, the mechanical capability limit of the post-processing unit can be obtained through communications with the MFP 2 as the specified upper limit A. Moreover, the user can also obtain a predetermined value by entering the model number of the post-processing unit or obtain a predetermined value stored in the printer driver. In step S507, it can be judged by inquiring, for example, the MFP 2 as to whether the post-processing breakup is possible. The decision process of the breakup position in the step S509 is as it has been described using FIG. 9.

Next, the post-processing breakup is set up in step S510 based on the breakup position decided in step S509 (S208). More specifically, the designation for the post-process dividing position is generated.

Next, in step S511, the printer driver prepares print data by converting the document file and transmits the prepared print data to the MFP 2 as a printing job. The print data contains the printing condition that includes the post-processing breakup as needed.

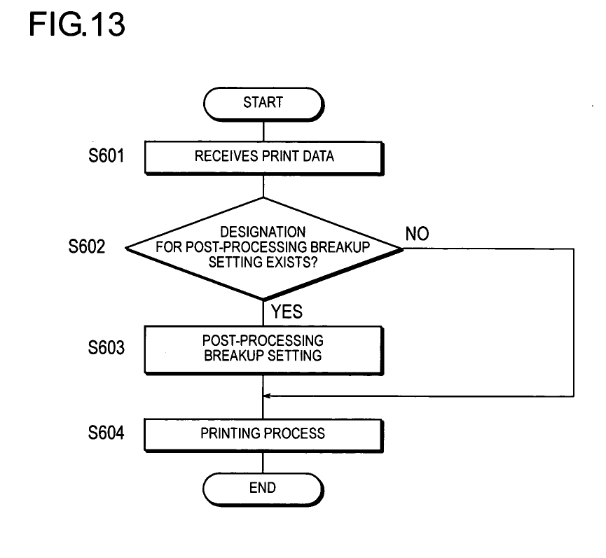

FIG. 13 is a flowchart showing the process for receiving the print data on a MFP 2 according to the third embodiment. The algorithm shown in the flowchart of FIG. 13 is stored as a program in a memory unit such as a hard disk 24 of MFP 2 and executed by a CPU 21.

First, the MFP 2 receives print data from the PC1 as the printing job (S601).

Next, a judgment is made as to whether any post-processing is designated for the received print data (S602). If it is judged that no post-processing is designated (S602: No), the program advances to the step S604.

When it is judged that the post-processing breakup is designated (S602: Yes), the post-processing breakup is set up based on the designated breakup position (S603).

In step S604, the printing process is performed. In other words, the images represented by the print data are printed on paper and the post-processing is applied to the printed paper as needed.

Thus, the post-processing breakup can be implemented based on the user's wish in the third embodiment as well as in the first embodiment.

The invention is not limited to the embodiments described above, but also can be changed in various ways within the scope of the claims.

For example, although the PC 1 is mentioned as the printing instruction device in the above embodiment, other printing instruction devices such as a portable terminal can be used as well.

For example, although MFP 2 is mentioned as the printing device in the above embodiment, other printing devices such as a copying machine and a printer can be used as well.

Moreover, although the user specifies the partitioning positions that correspond to partitions of the document on the setup screen displayed on the display 15 of the PC 1 using the printer driver and sets up at least one of the partitioning positions specified by the user's instruction as the post-processing breakup position for executing the post-processing on the printed paper by breaking it up in the above embodiments, that does not limit the present invention. For example, it is possible to adopt a constitution where the user specifies the partitioning positions that correspond to partitions of the document on the setup screen displayed on the operating panel unit 25 of the MFP 2 using the printer driver and sets up at least one of the partitioning positions specified by the user's instruction as the post-processing breakup position for executing the post-processing on the printed paper by breaking it up in the above embodiments.

The means and method of conducting various processes in the printing system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is normally transferred to and stored in a memory unit such as a hard disk. Said program can also be provided as independent application software or can be built into the software of the image processing device as a part of its function.

What is claimed is:

1. A printing management device for managing a document comprising:
an identification unit that identifies partitioning positions that correspond to partitions of a document; and
a control unit that sets up at least one of the identified partitioning positions as a breakup position for post-processing when post-processing is implemented by breaking up the document into sections on printed media.

2. The printing management device as claimed in claim 1, wherein
said partitioning position is a page denoting a chapter break of the document.

3. The printing management device as claimed in claim 1, wherein
said partitioning position is a page where an insertion paper is inserted into the document.

4. The printing management device as claimed in claim 1, wherein
said partitioning position is a page where printing conditions of the document change.

5. The printing management device as claimed in claim 1 further comprising:
an execution approval/rejection receiving unit for receiving the user's instruction on whether to approve or reject the implementation of said post-processing by breaking up the document into sections.

6. The printing management device as claimed in claim 5, wherein
said execution approval/rejection receiving unit receives the user's instruction on whether to approve or reject the implementation of said post-processing by breaking up the document into sections for each one of said partitioning positions.

7. The printing management device as claimed in claim 1 further comprises:
a priority instruction receiving unit for receiving the user's instruction as to the priority to be used in setting up a particular breakup position among said plurality of types of partitioning positions.

8. The printing management device as claimed in claim 1, wherein
the breakup of said post-processing is not executed if the number of recording media is less than or equal to an upper limit.

9. The printing management device as claimed in claim 8, wherein
even when said object to be post-processed is broken into multiple sectors, if the number of recording media to be post-processed at least in one sector among the particular multiple sectors broken up as described above exceeds said specified upper limit, said control unit further sets up a different type of partitioning position, which is different from the partitioning position used as said breakup position, as a second breakup position of said object to be post-processed.

10. The printing management device as claimed in claim 8, wherein
even when said object to be post-processed is divided into multiple sectors, if the number of recording media to be post-processed at least in one sector among the particular multiple sectors divided as described above exceeds said specified upper limit, said control unit further sets up a position that breaks up the particular sector evenly so that the number of recording media to be post-processed does not exceed said specified upper limit as a second breakup position of said object to be post-processed.

11. The printing management device as claimed in claim 1 further comprising:
a choice receiving unit for receiving the user's choice concerning whether or not to limit the breakup of said post-processing only to a case when the number of recording media to be post-processed exceeds a specified upper limit.

12. The printing management device as claimed in claim 8, wherein
the number of recording media to be post-processed is calculated in accordance with the printing condition specified by the user's operation.

13. A printing management device for managing a document comprising:
a receiving unit that receives a start request concerning document printing; and
a control unit in charge of control for displaying a setup screen comprising a separation position setup section for setting up a separation position that corresponds to a sector in a document in accordance with the user's instruction;
wherein one of the designated partitioning positions is set up as a breakup position of the object of post-processing when the post-processing is applied to the recording media after printing.

14. A printing management method for managing a document comprising:
identifying partitioning positions that correspond to partitions of a document; and
setting up at least one of the identified partitioning positions as a breakup position for post-processing when post-processing is implemented by breaking up the document into sections on printed media.

15. A printing management method for managing a document comprising:
receiving a start request concerning document printing; and
controlling a display of a setup screen comprising a separation position setup section for setting up a separation position that corresponds to a sector in a document in accordance with the user's instruction;
wherein one of the designated partitioning positions is set up as a breakup position of the object of post-processing when the post-processing is applied to the recording media after printing.

16. A computer readable recording medium stored with a printing management program for managing document printing, said printing management program causing a computer to execute a process comprising:
identifying partitioning positions that correspond to partitions of a document; and
setting up at least one of the identified partitioning positions as a breakup position for post-processing when post-processing is implemented by breaking up the document into sections on printed media.

17. A computer readable recording medium stored with a printing management program for managing document printing, said printing management program causing a computer to execute a process comprising:
receiving a start request concerning document printing; and
controlling a display of a setup screen comprising a partitioning position setup section for setting up a partitioning position that corresponds to a partition of a document in accordance with the user's instruction;
wherein one of the designated partitioning positions is setup as a breakup position of the object of post-processing when the post-processing is applied to the recording media after printing.
